(19) United States
(12) Patent Application Publication
(10) Pub. No.: US 2026/0367977 A1
(43) Pub. Date: Nov. 19, 2026

(54) Cache-aware workload scheduling

(71) Applicant: MELLANOX TECHNOLOGIES, LTD., Yokneam (IL)

(72) Inventors: Nitzan Carmi, Ramat Gan (IL); Itay Alroy, Nes Ziona (IL); Roman Spiegelman, Yokneam Illit (IL); Shai Malin, Tel Aviv (IL); Dana Benbasat, Givatayim (IL)

(21) Appl. No.: 19/207,451

(22) Filed: May 14, 2025

(51) Int. Cl. G06F 9/50

(52) U.S. Cl. CPC G06F 9/5027

(57) ABSTRACT

In one embodiment, a data processing unit (DPU) comprises a second memory to store job data of incoming jobs in designated warehouses, a first memory, and at least one processor to track pending ones of the jobs in each of the designated warehouses, and schedule execution of the pending jobs from the designated warehouses and move the job data from the designated warehouses in the second memory to the first memory based on the tracking and available space in the first memory in order to prevents cache misses.

### FIELD OF THE DISCLOSURE

The present disclosure relates to computing systems, and more particularly but not exclusively to cache-aware workload scheduling.

### BACKGROUND

Data processing units (DPUs) are specialized hardware components designed to offload and accelerate networking, storage, and security tasks from central processing units (CPUs) in data centers and cloud environments. These DPUs often utilize software frameworks to facilitate the development of applications and services that leverage the DPU's capabilities.

In typical DPU operations, jobs arrive via queue pairs (QPs) and are processed by various software entities or virtual functions running on the DPU. These jobs are often small in size, typically around 64 bytes, but when decoded and processed, they expand into larger contexts that can consume available cache memory on the DPU.

Cache memory plays a role in the performance of DPUs. The L1 and L2 caches, being closer to the processor, offer faster access times compared to L3 cache or main memory. Efficient utilization of cache memory can impact the overall processing speed and efficiency of the DPU.

DPUs often handle multiple types of jobs simultaneously, each potentially associated with different virtual functions or queue pairs. Managing these diverse workloads while maintaining optimal performance can present challenges in resource allocation and scheduling.

Hardware offload engines are frequently integrated into DPUs to accelerate specific tasks. These engines can include dedicated circuitry for operations such as encryption, compression, or network packet processing.

As data centers and cloud environments continue to evolve, there is ongoing interest in enhancing the efficiency and performance of DPUs to meet the demands of modern computing workloads.

### OVERVIEW

There is provided in accordance with an embodiment of the present disclosure, a data processing unit (DPU), comprising a second memory to store job data of incoming jobs in designated warehouses, a first memory, wherein the first memory is to provide faster processor access than the second memory, and at least one processor to track pending ones of the jobs in each of the designated warehouses, and schedule execution of the pending jobs from the designated warehouses and move the job data from the designated warehouses in the second memory to the first memory based on the tracking and available space in the first memory in order to prevents cache misses.

Further in accordance with an embodiment of the present disclosure, the at least one processor is to maintain counters in the first memory to track the number of pending jobs in each of the designated warehouses and schedule execution of the pending jobs based on the counter values.

Still further in accordance with an embodiment of the present disclosure, the at least one processor is to batch process multiple ones of the pending jobs from a same warehouse of the designated warehouses.

Additionally, in accordance with an embodiment of the present disclosure, the at least one processor is to prioritize processing the pending jobs from ones designated warehouses based on quality-of-service requirements.

Moreover, in accordance with an embodiment of the present disclosure, the at least one processor is to maintain priority information for each of the designated warehouses in the first memory.

Further in accordance with an embodiment of the present disclosure, the at least one processor is to schedule processing of jobs based on availability of hardware offload engines.

Still further in accordance with an embodiment of the present disclosure, the at least one processor is to avoid processing jobs associated with a bottlenecked hardware offload engine.

Additionally, in accordance with an embodiment of the present disclosure, each warehouse is associated with a specific queue pair.

Moreover, in accordance with an embodiment of the present disclosure, the second memory is to maintain separate ones of the designated warehouses for different types of virtual functions associated with a same queue pair.

Further in accordance with an embodiment of the present disclosure, the at least one processor is to receive notifications of new jobs added to the warehouses by a host device via a doorbell mechanism.

Still further in accordance with an embodiment of the present disclosure, the notifications include identifiers of ones of the designated warehouses to which new jobs have been added.

Additionally, in accordance with an embodiment of the present disclosure, the at least one processor is to execute the pending jobs using virtual functions associated with the jobs.

There is provided in accordance with another embodiment of the present disclosure, a host device, comprising a processor to generate jobs, and store job data of the jobs in designated warehouses in memory of a data processing unit (DPU), a memory to store data used by the processor.

Further in accordance with an embodiment of the present disclosure, the processor is to generate the jobs with different job-types, and store the jobs of different job-types in different ones of the designated warehouses.

Still further in accordance with an embodiment of the present disclosure, the different job-types are based on at least one of queue pair (QP), virtual function type, or a combination of QP and virtual function type.

Additionally, in accordance with an embodiment of the present disclosure, the processor is to store the jobs associated with different combinations of QP and virtual function type in separate ones of the designated warehouses.

Moreover, in accordance with an embodiment of the present disclosure, the processor is to assign priority levels to the generated jobs.

Further in accordance with an embodiment of the present disclosure, the processor is to notify the DPU of newly generated jobs via a doorbell mechanism.

Still further in accordance with an embodiment of the present disclosure, the processor is to store the jobs in the designated warehouses in the second memory of the DPU using direct memory access (DMA).

Additionally, in accordance with an embodiment of the present disclosure, the processor is to use a completion queue to notify the DPU when new jobs have been added to the warehouses.

There is also provided in accordance with still another embodiment of the present disclosure, a system, comprising a host device to generate jobs, and store job data of the jobs in designated warehouses in a second memory of a data processing unit (DPU), and the DPU coupled to the host device, the DPU comprising the second memory, a first memory, wherein the first memory is to provide faster processor access than the second memory, and at least one processor to track pending ones of the jobs in each of the designated warehouses, and schedule execution of the pending jobs from the designated warehouses and move the job data from the designated warehouses in the second memory to the first memory based on the tracking and available space in the first memory in order to prevent cache misses.

Further in accordance with an embodiment of the present disclosure, the host device is to generate the jobs with different job-types, and store the jobs of different job-types in different ones of the designated warehouses.

Still further in accordance with an embodiment of the present disclosure, the different job-types are based on at least one of queue pair (QP), virtual function type, or a combination of queue pair (QP) and virtual function type.

Additionally, in accordance with an embodiment of the present disclosure, the host device is to assign priority levels to the generated jobs, and wherein the DPU may schedule execution of the pending jobs based in part on the assigned priority levels.

Moreover, in accordance with an embodiment of the present disclosure, the host device is to store the jobs in the designated warehouses in the second memory of the DPU using direct memory access (DMA).

### BRIEF DESCRIPTION OF THE DRAWINGS

The present disclosure will be understood from the following detailed description, taken in conjunction with the drawings in which:

FIG. 1 is a simplified block diagram of a system constructed and operative in accordance with an embodiment of the present disclosure;

FIG. 2 is a simplified pictorial illustration of an arrangement of warehouses and virtual functions of the system of FIG. 1;

FIG. 3 is a flowchart including steps in a method of operation of the system of FIG. 1;

FIG. 4 is a flowchart including steps in another method of operation of the system of FIG. 1; and

FIG. 5 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

### Overview of Example Embodiments

Data processing units (DPUs) in modern data centers and cloud environments face significant challenges in efficiently managing and processing large volumes of incoming jobs. The current approach of immediately passing each incoming job to the appropriate software entity for processing can lead to performance issues, particularly in cache-sensitive applications. As the number of jobs increases and their expanded contexts exceed the size of the CPU cache, frequent cache misses occur, resulting in degraded performance and increased latency.

The existing methods lack efficient mechanisms for managing job priorities, balancing workloads across different virtual functions, and optimizing resource utilization, including both CPU cache and various hardware offload engines available on the DPU. This can lead to suboptimal use of system resources and reduced overall performance.

Possible solutions to address these issues might include implementing more sophisticated job scheduling algorithms or increasing the size of the CPU cache. However, these approaches may have drawbacks such as increased complexity, higher costs, or limited scalability.

Embodiments of the present disclosure address at least some of the above drawbacks by providing a system and method that introduces a warehouse mechanism to efficiently manage cache-sensitive workloads using a faster memory and slower memory, where the faster memory provides faster processor access than the slower memory. In some implementations, the faster memory may include L1 or L2 cache, while the slower memory may include L3 cache, DDR memory, or other forms of main memory within the DPU.

In some embodiments, the system stores incoming jobs in designated warehouses in the DPU's slower memory, such as L3 cache or DDR memory, while maintaining small counters in the faster memory, e.g., L1 or L2 cache to track the number of pending jobs in each warehouse. Job execution is scheduled based on faster memory availability and optionally hardware offload capacity.

In some implementations, the host device may utilize direct memory access (DMA) to transfer job data to the designated warehouses in the DPU's slower memory. The host device may store jobs in specific warehouses based on various criteria, such as the associated queue pair (QP), the target virtual function, or a combination of both. This approach may allow for efficient organization and management of different job types within the DPU's memory structure.

For example, the host device may allocate separate warehouses for jobs associated with different queue pairs, enabling streamlined processing of jobs from specific communication channels. Similarly, the host device may designate warehouses for particular virtual functions, facilitating optimized execution of jobs that require specific software entities or protocols. In some cases, the host device may employ a more granular approach, creating warehouses based on combinations of queue pairs and virtual functions, which may further enhance job processing efficiency.

By organizing jobs into warehouses based on these criteria, the system may improve faster memory utilization and reduce context switching overhead. This organization may also enable more effective scheduling and prioritization of jobs, as the DPU can more easily identify and group-related tasks for batch processing (e.g., by the same virtual function) or optimized execution.

This approach allows for efficient storage of a large number of jobs without impacting the critical faster memory performance. The system may schedule execution of pending jobs from the designated warehouses based on various factors, including the counter values stored in the faster memory. These counters may provide a quick reference for the number of pending jobs in each warehouse, allowing the scheduler to make informed decisions about which jobs to process next. For example, higher counter values for a particular warehouse may indicate opportunities for batch processing, allowing the system to group similar jobs together for more efficient execution.

In some cases, the system may consider the available space in the faster memory when scheduling job execution. By monitoring the current faster memory utilization, the scheduler may determine how many jobs can be moved from the slower memory to the faster memory without causing cache overflow or excessive cache misses.

The scheduler may also take into account the availability of hardware offload engines when making scheduling decisions. In some implementations, the system may prioritize jobs that can utilize available hardware offload capacity, potentially improving overall system throughput.

When scheduling jobs for execution, the system moves job data from the designated warehouses in the slower memory to the faster memory. This transfer may be performed based on the scheduling decisions, ensuring that only the necessary job data is brought into the faster memory. By carefully managing this data movement, the system may help prevent cache pollution and maintain efficient faster memory utilization.

Once the job data is in the faster memory, the system may execute the pending jobs using virtual functions associated with the jobs. These virtual functions may be software entities or processes running on the DPU that perform specific tasks or emulate certain protocols. The association between jobs and virtual functions may allow for efficient processing of different job types, as each virtual function may be optimized for handling particular kinds of workloads.

In some implementations, the system may employ batch processing techniques, grouping similar jobs from the same warehouse to improve overall system efficiency and reduce cache misses. This approach may allow for more efficient use of the faster memory and potentially improve the performance of the virtual functions executing the jobs.

In some cases, the system implements batch processing by grouping similar jobs from the same warehouse, improving overall system efficiency and reducing cache misses. The system can also apply quality of service (QoS) and priority mechanisms to balance workloads across different virtual functions, with priorities stored in the faster memory for quick access.

The solution provided by the present disclosure offers several advantages, including improved faster memory utilization, reduced cache misses, and enhanced overall performance of cache-sensitive applications running on DPUs. Additionally, it provides flexibility to implement various optimization strategies and adapt to changing workload characteristics.

### System Description

The following are descriptions of terms used in the claims and throughout the description:

A data processing unit (DPU) may refer to a hardware component that may offload and accelerate networking, storage, and security tasks from central processing units in various computing environments. For example, a DPU may handle network packet processing or storage encryption, freeing up the main CPU for application processing. A specific example is the NVIDIA BlueField DPU.

A processor may refer to an electronic circuit that can execute instructions and process data through arithmetic, logical, control and input/output operations. Examples include general-purpose central processing units (CPUs) that handle diverse computing tasks, or graphics processing units (GPUs), or specialized processors like network processors optimized for packet processing.

Hardware offload engines may refer to dedicated hardware components within a DPU that can accelerate specific types of data processing tasks through specialized circuitry. For example, encryption offload engines can perform AES encryption operations much faster than general-purpose processors, while compression engines can accelerate data compression/decompression tasks.

Packet processing circuitry may refer to specialized hardware components that can handle the processing of network packets, including tasks such as packet parsing, classification, modification and forwarding. For example, dedicated packet processing application-specific integrated circuits (ASICs) can perform wire-speed packet inspection and routing.

A network interface may refer to a hardware component that can connect a device to a computer network by handling the physical and data link layer communications. Examples include Ethernet network interface cards (NICs) that provide RJ45 ports for network connectivity, or specialized interfaces like InfiniBand adapters for high-performance computing networks.

A host device may refer to a computing device that may generate jobs and send them to the DPU for processing. Examples include servers that offload network processing to a DPU, or storage systems that use DPUs to handle storage operations like encryption or compression.

A faster memory or “first memory” may refer to memory with faster access times relative to slower memory or “second memory”. The faster memory may include, but is not limited to, L1 cache and/or L2 cache, and in some cases L3 cache.

A slower memory or “second memory” refers to memory with slower access times relative to the faster memory or “first memory”. The slower memory may include, but is not limited to, L3 cache, DDR memory, main memory, or other forms of larger capacity storage within the DPU.

Direct memory access (DMA) may refer to a feature that may allow hardware subsystems to access memory independently without requiring the central processor's intervention. For example, a host device using DMA can transfer data directly to DPU memory while the DPU continues other processing tasks.

A doorbell mechanism may refer to a method that can be used to notify a device about the availability of new data or tasks, typically implemented through memory-mapped registers or interrupts. For example, writing to a doorbell register can signal a DPU that new network jobs or packets have arrived for processing.

A queue pair may refer to a communication channel that may include a send queue and a receive queue used for data transfer between endpoints, commonly used in RDMA-capable networks. For example, in InfiniBand networks, applications use queue pairs to transfer data directly between application memory spaces.

A shared completion queue may refer to a queue that may indicate completion of job creation by the host and therefore act as a work queue for the incoming jobs by the DPU. For example, the DPU might monitor a shared completion queue to identify newly created jobs that are ready for processing across multiple warehouses.

Virtual functions may refer to software-based instances that can provide specific functionality, often, but not necessarily, used in virtualization contexts. For example, a single physical network interface might support multiple virtual functions, each appearing as a dedicated network interface to different virtual machines.

Jobs may refer to units of work or tasks that may be processed by the DPU, such as network packets requiring processing or storage operations needing encryption. For example, a job might involve encrypting a block of data or processing a batch of network packets.

Pending jobs may refer to jobs that have been received but may not yet be processed, waiting in queues or buffers for execution. For example, incoming jobs might be queued as pending jobs until the DPU can process them.

Job-types may refer to categories or classifications that may group jobs based on their characteristics or processing requirements. For example, network processing jobs might be categorized by protocol type (TCP/IP, UDP) or storage jobs might be classified by operation type (read, write, encrypt).

Job data may refer to information or content that may be associated with a job, including both the data to be processed and metadata about the processing requirements. For example, a network processing job might include packet payload data and routing information.

A job generator may refer to a component that may create or produce jobs for processing, such as application software generating network requests or storage operations. For example, a database application might generate jobs for data encryption or network transmission.

Batch process may refer to processing multiple jobs together as a group to improve efficiency through shared resource utilization. For example, processing multiple similar encryption jobs together can reduce setup overhead and improve faster memory utilization.

Execution may refer to carrying out or performing a job or task using computational resources. For example, executing a network processing job might involve parsing packet headers, applying security policies, and forwarding the packet.

Scheduling may refer to a process that may determine the order and/or timing of job execution based on various factors like priority, resource availability, and dependencies. For example, a scheduler might prioritize latency-sensitive network jobs over background storage operations.

Tracking may refer to activities that may involve monitoring or recording the status or progress of jobs through their lifecycle. For example, tracking might involve maintaining counters of pending jobs or recording completion status of executed jobs.

Notifications may refer to messages or signals that may indicate the occurrence of events, such as job completion or new job arrival. For example, a doorbell interrupt might notify the DPU of new jobs awaiting in a completion or work queue.

Warehouses may refer to designated storage areas in memory that may hold jobs before processing, organized by QP and/or virtual function. For example, separate warehouses might store jobs associated with different queue pairs and/or different virtual functions.

Counters may refer to values that may be used to keep track of the number of pending jobs in warehouses or other metrics. For example, each warehouse might have an associated counter tracking the number of jobs waiting for processing.

Cache misses may refer to events where requested data may not be found in the faster memory, requiring slower access to main memory. For example, if job data is not in faster memory when needed, a cache miss occurs and the data must be fetched from main memory.

Quality of service requirements may refer to performance, reliability, or priority specifications for different types of jobs or services. For example, real-time network traffic might have strict latency requirements while background tasks have lower priority.

Priority information or levels may refer to data that may indicate the relative importance or urgency of jobs for scheduling purposes. For example, critical system messages might have high priority while maintenance tasks have lower priority.

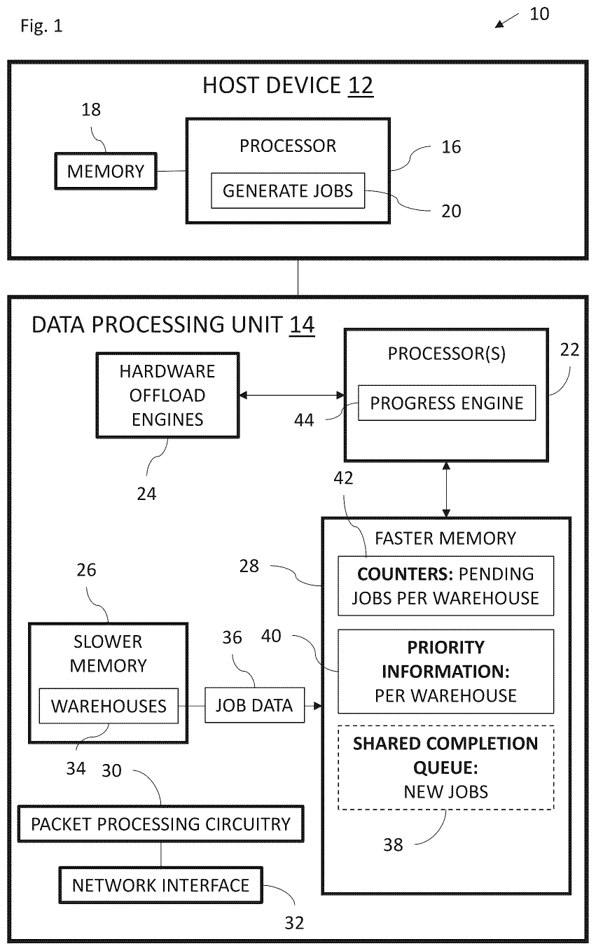

Reference is now made to FIG. 1, which is a block diagram illustrating a system 10 for efficient job processing and management. The system 10 includes a host device 12 and a data processing unit (DPU) 14 coupled to the host device 12 via a suitable data bus such as PCIe.

The host device 12 may include a processor 16, a memory 18, and a job generator 20. The job generator 20 may be configured to generate jobs for processing by the DPU 14. In some cases, the job generator 20 may be implemented as software executed by the processor 16. The memory 18 may store data used by processor 16.

The DPU 14 may include a processor 22, hardware offload engines 24, a slower memory 26, and a faster memory 28. The DPU 14 may also include packet processing circuitry 30 connected to a network interface 32.

The slower memory 26 may be configured to store job data 36 of incoming jobs in designated warehouses 34. The warehouses 34 may be designated memory areas within the slower memory 26 for storing jobs of different types or associated with different virtual functions.

The faster memory 28 may store various data structures used for job management and processing. These data structures may include a shared completion queue 38, priority information 40, and counters 42. The shared completion queue 38 may be used to notify the DPU 14 of newly added jobs. In some cases, the shared completion queue 38 may reside in the memory 18 of the host device 12 instead of the faster memory 28 of the DPU 14.

The processor 22 may execute a progress engine 44, which may be configured to monitor the faster memory 28, coordinate with the hardware offload engines 24, and manage job processing. The progress engine 44 may track pending jobs in each of the designated warehouses 34 using the counters 42 stored in the faster memory 28.

In operation, the host device 12 may generate jobs using the job generator 20 and store these jobs in the designated warehouses 34 within the slower memory 26 of the DPU 14. This storage operation may be performed using direct memory access (DMA) in some cases.

The progress engine 44 may schedule execution of pending jobs from the designated warehouses 34 based on various factors, including the tracking information provided by the counters 42 and available space in the faster memory 28. The processor 22 may move job data 36 from the designated warehouses 34 in the slower memory 26 to the faster memory 28 based on this scheduling.

By managing job execution in this manner, the system 10 may prevent cache misses that could occur if too many jobs were processed simultaneously, exceeding the capacity of the faster memory 28. This approach allows for efficient utilization of the faster memory 28 and may improve overall system performance.

The hardware offload engines 24 may be used to accelerate specific types of job processing tasks, while the packet processing circuitry 30 and network interface 32 may handle network-related operations for the DPU 14.

In some cases, the progress engine 44 may use the priority information 40 stored in the faster memory 28 to make decisions about job scheduling, ensuring that higher-priority jobs are processed more quickly when necessary.

This system architecture allows for efficient job management and processing, leveraging the strengths of both the host device 12 and the DPU 14 to handle a variety of computational tasks while optimizing resource utilization and preventing performance bottlenecks.

In the system described, counters 42 play a role in tracking and managing pending jobs within the designated warehouses. The counters may be implemented as numerical values stored in the faster memory 28 of the DPU 14, providing quick access for efficient job management.

The progress engine 44 may use counters 42 to keep track of the number of pending jobs in each warehouse 34. When new jobs are added to a warehouse 34, the corresponding counter 42 may be incremented. Similarly, when jobs are removed from a warehouse 34 for processing, the counter 42 may be decremented.

The host device 12 may update the counters 42 when it adds new jobs to the warehouses 34. For example, when the host device 12 stores job data in a designated warehouse 34 using DMA, it may also increment the associated counter 42 in the faster memory 28 to reflect the addition of a new job.

The DPU 14, specifically the progress engine 44, may update the counters 42 as it processes jobs. When the progress engine 44 schedules a job for execution and moves its data from the slower memory 26 to the faster memory 28, it may decrement the counter 42 for the corresponding warehouse 34.

In some implementations, the shared completion queue 38 may be used to facilitate counter updates. When the host device 12 adds a job to a warehouse 34, it may also add an entry to the shared completion queue 38. The progress engine 44 may then process these entries, updating the counters 42 accordingly.

In some cases, the system 10 may use separate read and write counters 42 for each warehouse 34. The host device 12 may update the write counter when adding jobs, while the DPU 14 may update the read counter when processing jobs. This dual-counter approach may allow for more efficient tracking of job flow through the system 10.

The counters 42 may also be used in conjunction with watermark levels. For example, the system 10 may define high and low watermarks for each warehouse 34. When a counter 42 exceeds the high watermark, it may trigger the progress engine 44 to prioritize processing jobs from that warehouse 34. Conversely, when a counter 42 falls below the low watermark, it may signal that the warehouse 34 is ready to receive more jobs from the host device 12.

By maintaining these counters 42 in the faster memory 28, the system 10 may achieve fast access times for job management operations, contributing to the overall efficiency of the job processing pipeline.

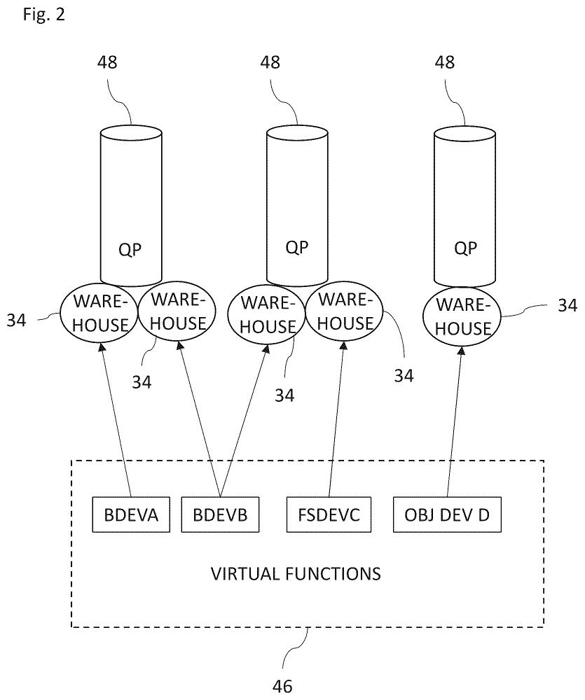

Reference is now made to FIG. 2, which is a system diagram showing an arrangement of warehouses 34 and virtual functions 46.

The system 10 includes multiple queue pairs (QPs) 48 associated with warehouses 34. A queue pair 48 may be a communication channel for transmitting and receiving data between a host device and a data processing unit (DPU). In some cases, each warehouse 34 may be associated with a specific queue pair 48.

The warehouses 34 may be memory structures located in the slower memory 26 (e.g., L3 cache or DDR memory) of the DPU 14. These warehouses 34 may store incoming jobs from the host device before the jobs are processed by virtual functions 46. The virtual functions 46 may be software entities or processes running on the DPU 14 that perform specific tasks or emulate certain protocols.

In some cases, the host device 12 may generate jobs with different job-types. These job-types may be based on queue pair (QP) and/or virtual function type. The host device may store jobs of different job-types in different designated warehouses 34. For example, jobs associated with different combinations of QPs and virtual function type may be stored in separate designated warehouses 34.

The arrangement shown in FIG. 2 demonstrates how jobs are associated with the queue pairs 48 and the warehouses 34 and the virtual functions 46. Each warehouse 34 may be connected to one or more virtual functions 46, as indicated by the connecting lines in the diagram. This arrangement allows for flexible job management and processing.

In some cases, the slower memory 26 of the DPU may maintain separate designated warehouses 34 for different types of virtual functions 46 associated with a same queue pair 48. This configuration may allow for more granular job management and processing within each queue pair.

The virtual functions 46 shown at the bottom of FIG. 2 include examples such as BDEVA, BDEVB, FSDEVC, and OBJ DEV D. These may represent different types of virtual functions, such as block devices or file system devices. Each virtual function 46 may receive job data from one or more warehouses 34, as indicated by the multiple connection lines between individual virtual functions and warehouses 34.

This flexible arrangement of warehouses 34, queue pairs 48, and virtual functions 46 may allow for efficient job management and processing in the DPU 14. By organizing jobs based on their types and associated virtual functions 46, the system 10 may optimize resource utilization and improve overall performance.

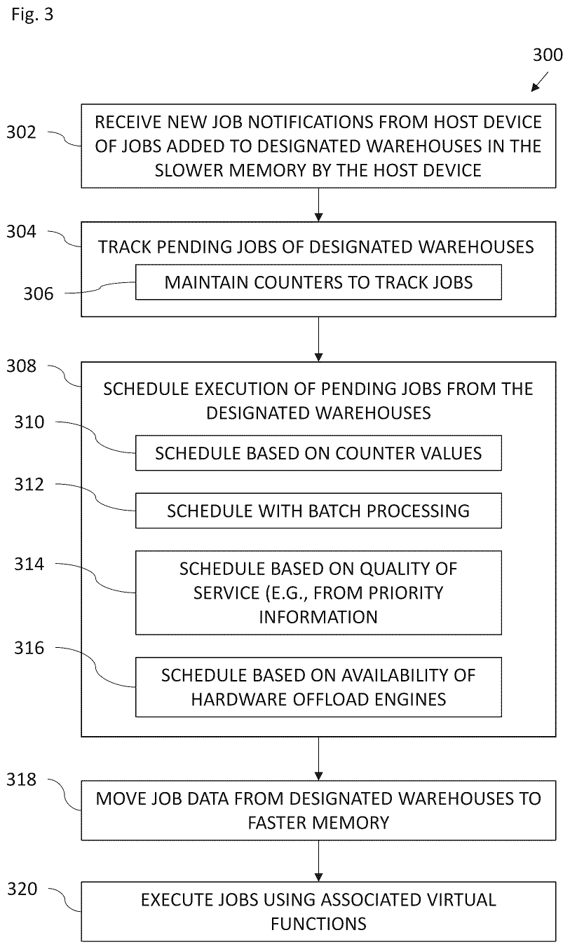

Reference is now made to FIG. 3, which is a flowchart illustrating a method 300 for processing jobs in a data processing unit (DPU). The method 300 may include multiple steps for efficient job management and execution.

The method 300 may begin with a step 302 of receiving new job notifications from a host device. These notifications may indicate that jobs have been added to designated warehouses in the slower memory of the DPU by the host device. In some cases, the notifications may include identifiers of the designated warehouses to which new jobs have been added. In some implementations, the host device may add job notifications to the shared completion queue, with each notification identifying the specific warehouse associated with the job. The host device may then use a doorbell mechanism to alert the DPU of new job notifications added to the shared completion queue. This approach may allow for efficient communication between the host device and the DPU regarding newly added jobs.

Following the receipt of notifications, the method 300 may proceed to a step 304 of tracking pending jobs in each of the designated warehouses. The tracking in step 304 may involve a step 306 of maintaining counters in the faster memory to track the number of pending jobs in each of the designated warehouses. Upon receiving the doorbell alert, the DPU may process the notifications in the shared completion queue, updating the relevant counters for each affected warehouse. In other embodiments, the counters may be updated by the host device when adding new jobs to the warehouses.

In some cases, the processor of the DPU (and optionally the host device) may maintain read and write pointers for each warehouse in the faster memory to facilitate efficient job management. These pointers may be updated as new job notifications are processed from the shared completion queue, allowing the DPU to quickly determine which jobs are pending and ready for execution.

The method 300 may then move to a step 308 of scheduling execution of pending jobs from the designated warehouses. This scheduling may be based on various factors and may involve several sub-steps. A step 310 may involve scheduling based on counter values, allowing the processor to efficiently manage job execution based on the current workload in each warehouse.

In some cases, the scheduling may include a step 312 of batch processing. The processor may batch process multiple pending jobs from a same warehouse of the designated warehouses, potentially improving efficiency by grouping similar jobs together.

A step 314 may involve scheduling based on quality-of-service requirements. The processor may prioritize processing the pending jobs from designated warehouses based on these requirements. To facilitate this, the processor may maintain priority information for each of the designated warehouses in the faster memory.

Additionally, a step 316 may involve scheduling based on the availability of hardware offload engines. The processor may schedule processing of jobs based on the current utilization and availability of these engines. In some cases, the processor may avoid processing jobs associated with a bottlenecked hardware offload engine, instead redirecting resources to other available engines or tasks.

After scheduling, the method 300 may proceed to a step 318 of moving job data from the designated warehouses in the slower memory to the faster memory. This movement may be based on the tracking and scheduling performed in the previous steps, as well as the available space in the faster memory. By carefully managing this data movement, the method 300 may help prevent cache misses and improve overall system performance.

Finally, the method 300 may include a step 320 of executing the jobs. The processor may execute the pending jobs using virtual functions associated with the jobs. This execution may be optimized based on the scheduling decisions made in the previous steps.

Throughout the method 300, the progress engine may make real-time decisions to optimize job processing across different virtual functions and hardware offload engines. This adaptive approach may allow the DPU to maintain high throughput even in the face of changing workloads or resource constraints.

In some cases, the method 300 may be implemented in a system where incoming jobs are stored in designated warehouses in the slower memory of the DPU by the host device. This storage arrangement may allow for efficient job management and processing, as described in the steps of the method 300.

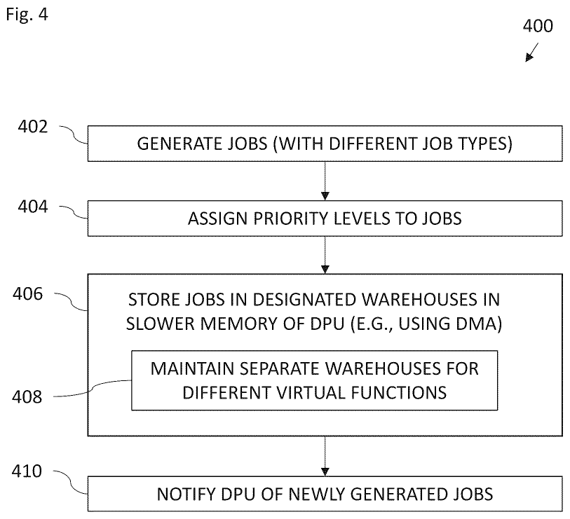

Reference is now made to FIG. 4, which is a flowchart illustrating a method 400 for generating jobs and storing jobs in a data processing unit (DPU). The method 400 includes several steps for managing job processing in a DPU environment.

A step 402 of the method 400 involves generating jobs with different job types. In some cases, a host device 12 may generate these jobs using a job generator 20. The job types may vary based on factors such as queue pair (QP), virtual function type, or a combination of both.

Following job generation, an optional step 404 of the method 400 involves assigning priority levels to the generated jobs. The host device 12 may assign these priority levels based on various criteria, such as the importance or urgency of the job.

A step 406 of the method 400 involves storing the jobs in designated warehouses 34 in a slower memory 26 of the DPU 14. In some cases, the host device 12 may use direct memory access (DMA) to store the jobs in the designated warehouses 34. This approach allows for efficient data transfer between the host device 12 and the DPU 14, reducing overhead and improving overall system performance.

Within step 406, a step 408 involves maintaining separate warehouses 34 for different virtual functions 46 (and optionally different QPs). This organization allows for more efficient job management and processing, as jobs related to specific virtual functions 46 (and optionally specific QPs) are grouped together.

The method 400 concludes with a step 410, where the DPU 14 is notified of newly generated jobs. In some cases, the host device 12 may use a doorbell mechanism to notify the DPU 14 of these new jobs and optionally add notifications of the new jobs to a shared completion queue. The notifications (e.g., in the shared completion queue) may include identifiers of the designated warehouses 34 to which new jobs have been added. The completion queue entries may contain metadata about the job, including the identifier of the warehouse 34 where the job has been stored.

The host device 12 may maintain data structures to track which jobs have been sent to which warehouses 34 on the DPU 14. This tracking allows the host device 12 to efficiently distribute new jobs across the available resources.

Upon receiving the notifications, the DPU 14 may use the information from the completion queue 38 entries to update counters 42 for the specific warehouses 34. These counters 42 may be used to track the number of pending jobs in each warehouse 34, allowing the DPU 14 to make informed decisions about job scheduling and processing.

In some cases, the method 400 may be implemented using different notification mechanisms or storage techniques. For example, instead of using a doorbell mechanism, the host device 12 may use interrupt-based notifications or shared memory flags to inform the DPU 14 of new jobs. Additionally, the job storage process may be optimized for different types of DPU architectures or memory configurations.

In some cases, the data processing unit may store incoming jobs in the designated warehouses instead of the host device using direct memory access. The data processing unit may receive job data from the host device and allocate the jobs to appropriate warehouses based on job type, associated virtual function, or other criteria.

Alternative warehouse organizations may be implemented. For example, warehouses may be organized based on job priority levels rather than or in addition to virtual function type and/or QP. This organization may allow for more efficient processing of high-priority jobs across different virtual functions.

The scheduling algorithm used by the progress engine may be modified to incorporate machine learning techniques. In some cases, the progress engine may use historical data on job processing times and resource utilization to predict optimal scheduling patterns and improve overall system performance.

Different hardware configurations of the data processing unit may be employed. For example, the data processing unit may include multiple processors working in parallel to manage job scheduling and execution. In some cases, dedicated hardware accelerators may be used for specific job types or virtual functions.

The system may implement dynamic warehouse allocation. The number and size of warehouses may be adjusted in real-time based on workload characteristics and system performance metrics. This dynamic allocation may optimize memory usage and improve job processing efficiency.

In some cases, the system may implement a hierarchical warehouse structure. Large warehouses may contain sub-warehouses for more granular job organization and processing. This structure may allow for more flexible and efficient job management, especially in systems with complex virtual function hierarchies.

Alternative faster memory management strategies may be employed. For example, the system may implement a tiered faster memory structure with multiple levels of faster memory, each optimized for different types of job data or processing stages.

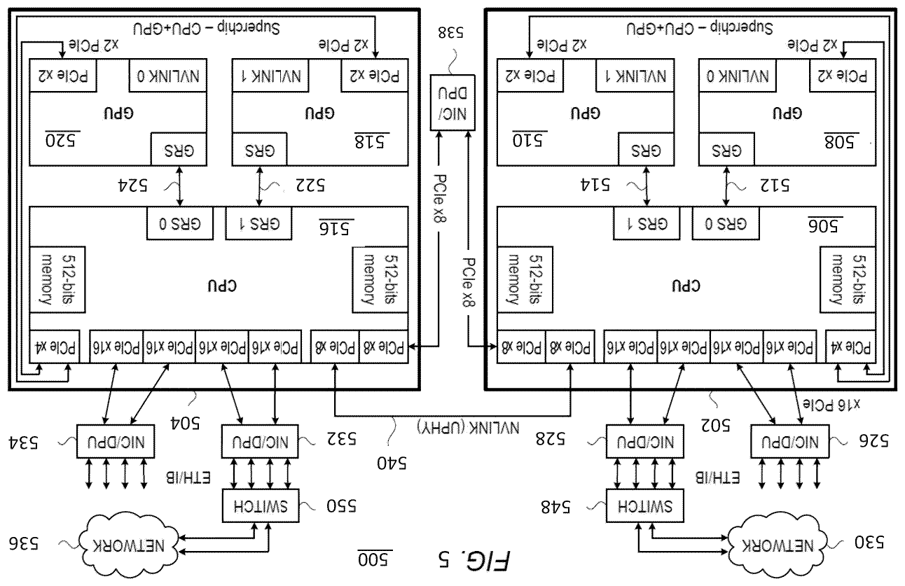

Reference is now made to FIG. 5, which is a block diagram that schematically illustrates a computing system 500, e.g., a data center or a High-Performance Computing (HPC) cluster, in accordance with an embodiment of the present disclosure.

System 500 comprises a plurality of subsystems, e.g., multiple processing devices coupled to each other, multiple network devices, and multiple networks, according to at least one embodiment. Computing system 500 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 500 and to one or more external networks 530, 536. In the present example, system 500 comprises a packet switch 548 that connects NIC/DPU 528 to network 530, and a packet switch 550 that connects NIC/DPU 532 to network 536.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 500 can include one or more CPUs and one or more GPUs.

FIG. 5 also demonstrates an example architecture of a multi-GPU architecture. As illustrated in the figure, computing system 500 includes a processing device 502 with a multi-GPU architecture. In particular, processing device 502 may be a system-on-chip and includes multiple subsystems such as a CPU 506, a GPU 508, and a GPU 510. CPU 506 can be coupled to GPU 508 via a die-to-die (D2D) or chip-to-chip (C2C) interconnect 512, such as a Ground-Referenced Signaling interconnect (GRS interconnect). CPU 506 can be coupled to GPU 510 via a D2D or C2C interconnect 514. CPU 506 can also couple to GPU 508 and GPU 510 via PCIe interconnects.

CPU 506 can be coupled to one or more NICs or DPUs, which are coupled to one or more networks. For example, as illustrated in FIG. 5, CPU 506 is coupled to a first NIC/DPU 526, which is coupled to a network 530. CPU 506 is also coupled to a second NIC/DPU 528, which is coupled to network 530 via switch 548. NIC/DPU 526 and NIC/DPU 528 can be coupled to network 530 over Ethernet (ETH), NVLINK or InfiniBand (IB) connections, for example.

Computing system 500 also includes a processing device 504 with a multi-GPU architecture. In particular, processing device 504 includes multiple subsystems including a CPU 516, a GPU 518, and a GPU 520. CPU 516 can be coupled to GPU 518 via a D2D or C2C interconnect 522. CPU 516 can be coupled to GPU 520 via a D2D or C2C interconnect 524. CPU 516 can also couple to GPU 518 and GPU 520 via PCIe interconnects. CPU 516 can be coupled to one or more NICs or DPUs, which are coupled to one or more networks. For example, as illustrated in FIG. 5, CPU 516 is coupled to a first NIC/DPU 532, which is coupled to a network 536. CPU 516 is also coupled to a second NIC/DPU 534, which is coupled to network 536 via switch 550. NIC/DPU 532 and NIC/DPU 534 can be coupled to network 536 over Ethernet (ETH), NVLINK or InfiniBand (IB) connections.

In at least one embodiment, processing device 502 and processing device 504 can communicate with each other via a NIC/DPU 538, such as over PCIe interconnects. Processing device 502 and processing device 504 can also communicate with each other over a high-bandwidth communication interconnect 540, such as an NVLink interconnect or other high-speed interconnects. The packet switches in FIG. 5 may comprise, for example, Nvidia Quantum-2 switches. The NICs/DPUs in the figure may comprise, for example, Nvidia Bluefield DPUs.

The data processing unit (DPU) may include a NIC and one or more processing cores. The NIC may include any of the following: an Ethernet Port (RJ45 Connector), which is the physical interface where the network cable (usually an Ethernet cable) connects to the NIC and is used for wired network connections; packet processing hardware or circuitry, which is responsible for handling network communication and processes incoming and outgoing data packets and manages the network interface functions; a memory (such as RAM or ROM) to store temporary data, such as network packet buffers, configuration settings, and firmware, and helps in speeding up data transfer and processing; firmware, which is software programmed into the NIC's memory and controls the hardware operations and may perform firmware updates to improve performance or add new features to the NIC; LED Indicators that provide visual indicators of network status, common indicators including power status, network activity, and link speed; a bus Interface (e.g., PCI or PCIe) to connect the NIC to the host computer's motherboard; a processor to handle network processing tasks as well as other processing tasks to offload work from the main CPU of the host device and improve network performance; a heat sink or cooling mechanism (e.g., for high-performance NICs), especially those used in servers, to prevent overheating; power management circuitry to ensure the NIC receives the correct amount of power and manages power consumption efficiently; and/or connector pins and circuitry including internal connections and pathways that route signals between the NIC's components.

The packet processing hardware or circuitry is the central component of the NIC and handles network communications. It may include several key components that work together to manage and process network data, such as any one or more of the following: MAC (Media Access Control) Layer, which is responsible for handling the data link layer of the OSI model and manages how data packets are formatted, addressed, and transmitted over the network; MAC address register, which stores the unique hardware address (MAC address) of the NIC; a frame buffer that temporarily holds data frames as they are being processed; a PHY (Physical Layer) Interface that interfaces with the physical medium (such as Ethernet cables) and is responsible for the actual transmission and reception of data bits over the network; a transceiver that converts data between the digital signals used by the MAC layer and the analog signals used for transmission over the network medium; DMA (Direct Memory Access) Controller that manages data transfers between the NIC and the computer's memory without involving the CPU and helps to offload processing tasks from the CPU and improve data transfer efficiency; a packet Processing Engine that handles the encapsulation and decapsulation of network packets, and processes incoming and outgoing packets, managing tasks like error checking and packet filtering; buffer management, which includes memory areas for storing packets temporarily, such as transmit buffers to store packets that are being sent from the computer to the network, receive buffers to store packets received from the network before they are processed by the system; an interrupt controller that manages and generates interrupts to notify the CPU of events such as packet reception or transmission completion and helps in efficient handling of network events; a clock generator, which provides timing signals for the various components of the NIC to synchronize their operations; a power management unit to regulate power consumption and manages power-saving features of the NIC chip to improve energy efficiency; error handling and correction logic, which detects and corrects errors in data transmission and reception, and may include features for error-checking protocols like CRC (Cyclic Redundancy Check); configuration registers that store configuration settings and parameters that control the NIC's operation, such as speed settings, interrupt configurations, and buffer sizes; firmware/ROM that contains the embedded software that controls the NIC's operations and manages network protocols.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The flowchart and block diagrams in the figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

As used herein, the singular form “a”, “an” and “the” include plural references unless the context clearly dictates otherwise.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A data processing unit (DPU), comprising:
a second memory to store job data of incoming jobs in designated warehouses;
a first memory, wherein the first memory is to provide faster processor access than the second memory; and
at least one processor to:
track pending ones of the jobs in each of the designated warehouses; and
schedule execution of the pending jobs from the designated warehouses and move the job data from the designated warehouses in the second memory to the first memory based on the tracking and available space in the first memory in order to prevents cache misses.

2. The DPU according to claim 1, wherein the at least one processor is to maintain counters in the first memory to track the number of pending jobs in each of the designated warehouses and schedule execution of the pending jobs based on the counter values.

3. The DPU according to claim 1, wherein the at least one processor is to batch process multiple ones of the pending jobs from a same warehouse of the designated warehouses.

4. The DPU according to claim 3, wherein the at least one processor is to prioritize processing the pending jobs from ones of the designated warehouses based on quality-of-service requirements.

5. The DPU according to claim 4, wherein the at least one processor is to maintain priority information for each of the designated warehouses in the first memory.

6. The DPU according to claim 1, wherein the at least one processor is to schedule processing of jobs based on availability of hardware offload engines.

7. The DPU according to claim 6, wherein the at least one processor is to avoid processing jobs associated with a bottlenecked hardware offload engine.

8. The DPU according to claim 1, wherein each warehouse is associated with a specific queue pair.

9. The DPU according to claim 8, wherein the second memory is to maintain separate ones of the designated warehouses for different types of virtual functions associated with a same queue pair.

10. The DPU according to claim 1, wherein the at least one processor is to receive notifications of new jobs added to the warehouses by a host device via a doorbell mechanism.

11. The DPU according to claim 10, wherein the notifications include identifiers of ones of the designated warehouses to which new jobs have been added.

12. The DPU according to claim 1, wherein the at least one processor is to execute the pending jobs using virtual functions associated with the jobs.

13. A host device, comprising:
a processor to:
generate jobs; and
store job data of the jobs in designated warehouses in memory of a data processing unit (DPU).
a memory to store data used by the processor.

14. The host device according to claim 13, wherein the processor is to generate the jobs with different job-types, and store the jobs of different job-types in different ones of the designated warehouses.

15. The host device according to claim 14, wherein the different job-types are based on at least one of: queue pair (QP), virtual function type, or a combination of QP and virtual function type.

16. The host device according to claim 15, wherein the processor is to store the jobs associated with different combinations of QP and virtual function type in separate ones of the designated warehouses.

17. The host device according to claim 13, wherein the processor is to assign priority levels to the generated jobs.

18. The host device according to claim 13, wherein the processor is to notify the DPU of newly generated jobs via a doorbell mechanism.

19. The host device according to claim 13, wherein the processor is to store the jobs in the designated warehouses in the second memory of the DPU using direct memory access (DMA).

20. The host device according to claim 13, wherein the processor is to use a completion queue to notify the DPU when new jobs have been added to the warehouses.

21. A system, comprising:
a host device to:
generate jobs; and
store job data of the jobs in designated warehouses in a second memory of a data processing unit (DPU); and
the DPU coupled to the host device, the DPU comprising:
the second memory;
a first memory, wherein the first memory is to provide faster processor access than the second memory; and
at least one processor to:
track pending ones of the jobs in each of the designated warehouses; and
schedule execution of the pending jobs from the designated warehouses and move the job data from the designated warehouses in the second memory to the first memory based on the tracking and available space in the first memory in order to prevent cache misses.

22. The system according to claim 21, wherein the host device is to generate the jobs with different job-types, and store the jobs of different job-types in different ones of the designated warehouses.

23. The system according to claim 22, wherein the different job-types are based on at least one of: queue pair (QP), virtual function type, or a combination of queue pair (QP) and virtual function type.

24. The system according to claim 21, wherein the host device is to assign priority levels to the generated jobs, and wherein the DPU may schedule execution of the pending jobs based in part on the assigned priority levels.

25. The system according to claim 21, wherein the host device is to store the jobs in the designated warehouses in the second memory of the DPU using direct memory access (DMA).
